(19) United States
(12) Patent Application Publication
(10) Pub. No.: US 2021/0037004 A1
(43) Pub. Date: Feb. 4, 2021

(54) SIGNING IN TO MULTIPLE ACCOUNTS WITH A SINGLE GESTURE

(71) Applicant: Microsoft Technology Licensing, LLC, Redmond, WA (US)

(72) Inventors: Ariel Gordon, Mercer Island, WA (US); Yordan I. Rouskov, Seattle, WA (US)

(21) Appl. No.: 16/525,089

(22) Filed: Jul. 29, 2019

(51) Int. Cl. H04L 29/06

(52) U.S. Cl. CPC H04L 63/0815; H04L 63/0853; H04L 63/0861

(57) ABSTRACT

Methods, systems and computer program products are provided for signing into multiple accounts with a single gesture. Multiple sessions may be generated for multiple user identities based on a single authentication gesture, such as providing a phone number or email and a texted or emailed one-time code or providing a fast online identity (FIDO) key and an unlock gesture. Resources, such as applications, need not, but may be multi-identity aware to support signing into multiple accounts with a single gesture. Users may utilize their multiple identities without any additional sign-ins. Resources or session managers may receive multiple session artifacts concurrently or separately without additional sign-ins. Resources may indicate a capability to receive multiple session artifacts, for example, in registration or call parameters. Multiple identities may be revealed only after verification, for example, to prevent divulging identities to third parties aware of usernames such as phone numbers and email addresses.

### BACKGROUND

Users are traditionally required to remember many different credentials (e.g. usernames and passwords) to log in to many different accounts. One account is traditionally associated with one username and set of credentials. Each set of credentials must be provided to log in to each account. This leads to consumption of time and resources as users search for credentials or request password resets and repeatedly go through log in procedures with different sets of credentials to activate multiple user identities (e.g. personal and business identities) with the same application. Furthermore, authorization procedures may prematurely divulge multiple accounts associated with a single username before credential verification (e.g. by requiring a user to select an identity from among multiple identities before providing credentials), which may inadvertently provide user identities to a potentially malicious person aware of a username (e.g. phone number, email address).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for signing into multiple accounts with a single gesture. Multiple sessions may be generated for multiple user identities based on a single authentication gesture, such as providing a phone number or email and a texted or emailed one-time code, or providing a fast online identity (FIDO)-compatible key and an unlock gesture (e.g. biometric information or a PIN). Resources, such as applications, need not, but may be, multi-identity aware to support signing into multiple accounts with a single gesture. Resources may indicate a capability to receive multiple session artifacts, for example, in registration or call parameters. Resources or session managers may receive multiple session artifacts, concurrently or separately, without any additional sign-ins. Users may utilize their multiple identities without any additional sign-ins. Multiple identities may be revealed only after verification, for example, to prevent divulging identities to third parties aware of usernames

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for signing in to multiple accounts with a single gesture, according to an example embodiment.

FIGS. 2A and 2B are examples of a user interface for signing in to multiple accounts with a single gesture, according to an example embodiment.

FIG. 3 shows a flowchart of a method for signing in to multiple accounts with a single gesture, according to an example embodiment.

FIG. 4 shows a flowchart of a method for signing in to multiple accounts with a single gesture, according to an example embodiment.

FIG. 5 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner

### II. Example Implementations

User access control may be provided by authentication (e.g. and authorization). Authentication is a process of proving that a user is who the user claims to be. Authentication may challenge a party for legitimate credentials (e.g. username, password, biometric information), for example, as a basis to create a security principal used for identity and access control. Authentication may be referred to as AuthN. Authorization is the act of granting an authenticated security principal permission to do something. Authorization may specify what data a party (e.g. user) is allowed to access and what the party can do with it. Authorization may be referred to as AuthZ.

Authentication may be provided by an authentication service. An authentication service may provide a security (e.g. identity or access) token to a user who provides legitimate credentials. Resources (e.g. that do not perform their own independent authentication) may require a user to provide an access token, which they may validate (e.g. with the authentication service).

In an example, an access token may be accompanied by metadata about the access token (e.g. for consumption by an application or resource receiving a token). In an example, metadata information may include an expiry time of an access token and the scope(s) for which the access token is valid. This data may permit applications and resources to intelligently cache access tokens without having to parse the access token itself. Access tokens may provide helpful information for use in authentication and authorization validation, such as the user, client, issuer, permissions, etc.

In an example, an access token may comprise a JavaScript Object Notation (JSON) web token (referred to as a JWT) object signed by an authentication provider. A JWT may comprise three pieces (e.g. a header, payload or body and signature). A header may provide information about how to validate a token (e.g. including information about the type of token and how it was signed, such as the key and encryption method used to sign the token). A payload may contain data about a user or application that may be calling an application or resource (e.g. service, database). A signature may comprise raw material that may be used to validate a token. In an example, a token issued by an authentication provider may be signed using an asymmetric encryption algorithm, such as RSA 256. Pieces of a JWT object may be separated by a period and (e.g. separately) Base64 encoded.

A token may be validated (e.g. by a resource that receives the token), for example, by validating a signature and any claims in the token. A claim may be present, for example, when a value exists to fill it. A signature may be used to validate the authenticity of a token so that it can be trusted by a resource (e.g. application). An ID token may be used to validate that a user is who the user claims to be and may be used to obtain additional useful information about the user. An access token may be used to validate user access authorization.

Authorization is the process of determining which securable resources a principal can access, and which operations are allowed for those resources. Authorization may be provided by an authorization provider. An authorization provider may be implemented in a particular application or resource or may be implemented externally applicable across multiple resources.

Authorization may, for example, use role-based access control (RBAC). RBAC may restrict access based on a user's role in or relationship to an enterprise. In an example, RBAC may give an employee or customer access rights to information needed to perform their job or related to their company and prevent them from accessing information that doesn't pertain to their job or company.

User authentication and authorization may be provided by a cloud service. Multiple user identities and access privileges may be created, for example, by a user and/or by cloud service customers, such as companies providing identities and access privileges for employees. Microsoft® Azure® Active Directory® (AD) is an example of a cloud-based identity and access management service provider. In an example, a person may work for several companies and each company may specify a user identity and access privileges for the person (e.g. user), for example, with a cloud-based identity and access management service provider. The user or each company may specify a passwordless credential for a user, such as: (i) a user's phone number combined with a one-time code (OTC) texted or phoned to the user's phone number and entered by the user, (ii) a user's email address and the OTC emailed to the user's email address and entered by the user, or (iii) a cryptographic key (e.g. FIDO-compatible key) and an unlock gesture (e.g. biometric information or a PIN). Regardless of implementation, a user may have multiple identities.

A user may log in, for example, when a resource is secured by proof of identity. Additional security, such as authorization to access or use resources to varying degrees depending on identity, may be applied in various implementations. In an example, social media may generally provide users with the same resource usage while a business may vary resource access and use among particular employees and customers.

A user may provide credentials when logging in to one or more identities, accounts or contexts. An identity is a (e.g. digital) representation of a user. An identity may be provided by a user account. A user may have multiple identities (e.g. multiple accounts). Identities may have contexts. For example, an identity context may be based on circumstantial information (e.g. user environment, activity, location, software, hardware, domain and so on). A context may be used to vary an identity (e.g. user representation, access). A user who wants to sign in to the same (e.g. online) service with two separate contexts or identities may be forced to present two separate sets of credentials in two separate sign-on procedures. For example, a user may click “sign in” to an application, be redirected to an authorization service, provide a first set of credentials, be redirected back to the application, select “add another account,” be redirected back to the authorization provider, provide a second set of credentials, be redirected back to the application to work alternately or concurrently with both contexts or identities, e.g., depending on the capabilities of the application. Multiple login procedures are generally required, even for applications that permit users to alternatively or concurrently view information for multiple accounts even when users have the same credentials for multiple accounts (e.g. cell phone number as user name and OTC). A remedy for this problem is to log users in to multiple accounts, identities or contexts with a single gesture.

Methods, systems and computer program products are provided herein for signing into multiple accounts with a single gesture. Multiple sessions may be generated for multiple user identities based on a single authentication gesture, such as providing a phone number or email and a texted or emailed one-time code, or providing a fast online identity (FIDO)-compatible key and an unlock gesture (e.g. biometric information or a PIN). Resources, such as applications, need not, but may be, multi-identity aware to support signing into multiple accounts with a single gesture. Resources may indicate a capability to receive multiple session artifacts, for example, in registration or call parameters. Resources or session managers may receive multiple session artifacts, concurrently or separately, without any additional sign-ins. Users may utilize their multiple identities without any additional sign-ins. Multiple identities may be revealed only after verification, for example, to prevent divulging identities to third parties aware of usernames

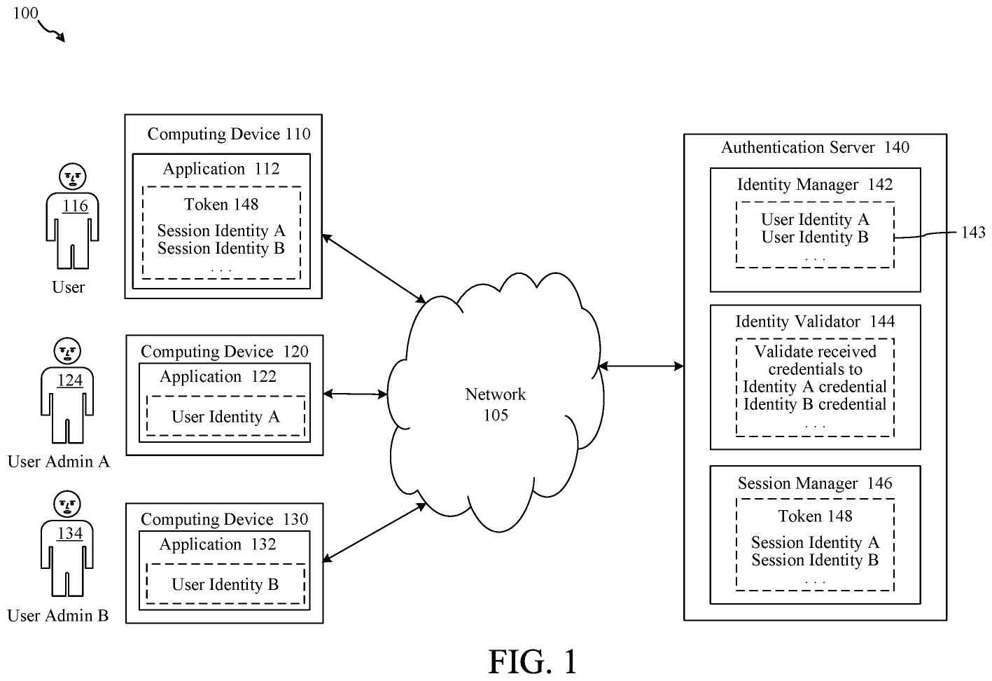

FIG. 1 shows a block diagram of a system for signing in to multiple accounts with a single gesture, according to an example embodiment. Example system 100 presents one of many possible example implementations. System 100 may comprise any number of computing devices and/or servers, such as example components illustrated in FIG. 1 and other additional or alternative devices not expressly illustrated. Other types of computing environments involving signing in to multiple accounts with a single gesture are also contemplated. Example system 100 includes network 105, computing devices 110, 120 and 130, user 116, user admin A 124, user admin B 134, and authentication server 140.

Network 105 may include one or more of any of a local area network (LAN), a wide area network (WAN), a personal area network (PAN), a combination of communication networks, such as the Internet, and/or a virtual network. In example implementations, computing devices 110, 120, 130 and authentication server 140 may be communicatively coupled via network 105. In an implementation, any one or more of authentication server 140 and computing devices 110, 120, 130 may communicate via one or more application programming interfaces (APIs), and/or according to other interfaces and/or techniques. Authentication server 140 and computing devices 110, 120, 130 may each include at least one network interface that enables communications with each other. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Various communications between networked components may utilize, for example, HTTP, Open Authorization (OAuth), which is a standard for token-based authentication and authorization over the Internet). Information in communications may be packaged, for example, as JSON or XML files.

Computing devices 110, 120, 130 may comprise any computing device utilized by one or more users (e.g., individual users, family users, enterprise users, governmental users, etc.). Computing devices 110, 120, 130 may comprise one or more applications, operating systems, virtual machines, storage devices, etc. that may be executed, hosted, and/or stored therein or via one or more other computing devices via network 105. In an example, computing devices 110, 120, 130 may access one or more server devices, such as authentication server 140, to access one or more secured resources (e.g. applications, databases). Computing devices 110, 120, 130 may represent any number of computing devices. User 116, user admin A 124 and user admin B 134 may represent any number of persons authorized in their respective roles. Computing devices 110, 120, 130 may each be may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing devices 110, 120, 130 are not limited to physical machines, but may include other types of machines or nodes, such as a virtual machine. Computing devices 110, 120, 130 may each interface with authentication server 140 through APIs and/or by other mechanisms. Any number of program interfaces may coexist on computing devices 110, 120, 130.

Computing device 120 may be used, for example, by user admin A 124 to create and manage user identities, credential requirements, user privileges, log-in procedures, etc. User admin A 124 may have administrative privileges on all or a portion of authentication server 140. In an example, authentication server 140 may comprise a cloud service available to many customers. In an example, user admin A 124 may comprise a user admin in company A, such as an international enterprise with thousands of employees in many countries with a variety of roles in the enterprise. User admin A 124 may use application 122 displayed by computing device 120 to specify user identities (e.g. user identity A for user 116) to authentication server 140 via network 105. Application 122 may comprise, for example, a Web application provided by authentication server 140. User admin A 124 may, for example, use application 122 to create user identity A in identity manager 142 in authentication server 140. User admin A may, for example, specify user identity A credentials, such as: (i) a user's cell phone number combined with a password or a randomly generated one-time code (OTC) that would be texted to the user's phone number and entered by the user, (ii) a user's email address and a password or an OTC that would be emailed to the user's email address and entered by the user, (iii) a cryptographic key (e.g. FIDO-compatible key) and an unlock gesture (e.g. biometric information or a PIN). A user (e.g. user 116) may subsequently change and maintain a password, which may be made consistent with other credentials for other identities.

Computing device 130 may be used, for example, by user admin B 134 to create and manage user identities, credential requirements, user privileges, log-in procedures, etc. User admin B 134 may have administrative privileges on all or a portion of authentication server 140. In an example, authentication server 140 may comprise a cloud service available to many customers. In an example, user admin B 134 may comprise a user admin in company B, such as an international enterprise with thousands of employees in many countries with a variety of roles in the enterprise. User admin B 134 may use application 132 displayed by computing device 130 to specify user identities (e.g. user identity B for user 116) to authentication server 140 via network 105. Application 132 may comprise, for example, a Web application provided by authentication server 140. User admin B 134 may, for example, use application 132 to create user identity B in identity manager 142 in authentication server 140. User admin B may, for example, specify user identity B credentials, such as: (i) a user's cell phone number combined with a password or a randomly generated one-time code (OTC) that would be texted to the user's phone number and entered by the user, (ii) a user's email address and a password or an OTC that would be emailed to the user's email address and entered by the user, (iii) a cryptographic key (e.g. FIDO-compatible key) and an unlock gesture (e.g. biometric information or a PIN). A user (e.g. user 116) may subsequently change and maintain a password, which may be made consistent with other credentials for other identities.

Computing device 110 may be used, for example, by user 116 to access computing resources, which may require user authentication. User 116 may create one or more (e.g. personal, business and/or other) identities, for example, in identity manager 142. User 130 may (e.g. additionally and/or alternatively), for example, have a role (e.g. engineer, accountant, manager, executive, contractor) within one or more enterprises, such as company A and company B, which may create, for example, user identity A and user identity B for user 116. Regardless of implementation details, user 116 may have multiple identities (e.g. one or more personal and/or one or more business identities) managed by identity manager 142. Multiple identities may be associated with the same credential(s), such as: (i) a user's cell phone number combined with a password or a randomly generated one-time code (OTC) that would be texted to the user's phone number and entered by the user, (ii) a user's email address and a password or an OTC that would be emailed to the user's email address and entered by the user, (iii) a cryptographic key (e.g. FIDO-compatible key) and an unlock gesture (e.g. biometric information or a PIN). User 116 may manage credentials (e.g. passwords, phone numbers), for example, to make them consistent with other credentials for multiple identities.

User login credentials may comprise any information that may be used to verify user identity. Credential categories may be generalized as something a user knows (e.g. answers to one or more prompts or questions, such as a username, a password, a name of first pet and so on), something a user has (e.g. a device storing a cryptographic key) or something a user is (e.g. biometric information, such as retina scan, face scan, fingerprint and so on). Multi-factor authentication (MFA) may combine multiple types of credentials.

A username may comprise any string of characters, images (e.g. pattern with coded data) or blob of information. In an example, a username may comprise a random string of characters, a cellular telephone number, an email address and so on.

A password may comprise any string of characters and/or images (e.g. pattern with coded data). In an example, a password may comprise a one-time code (OTC), which may be sent to a user during a login procedure to ensure that the user is in possession of a device or account, such as a cellular phone number and/or an email address specified during the creation of a user identity.

FIDO is an industry standard that may replace a multitude of user credentials (e.g. usernames and passwords) with hardware backed credentials. A FIDO-compatible implementation may involve providing a digital key to sign in, for example, at an application or operating system (OS) level. In an example, employers may provide employees with a USB dongle or smart card configured with a FIDO protocol. A user with multiple jobs and identities may have multiple hardware devices. A user may prefer to reuse the same hardware device across multiple jobs and identities. Multiple authentication devices, whether FIDO or other authentication protocol, may be reduced or avoided, for example, by configuring a (e.g. single) device as a FIDO credential for multiple user identities. For example, a user's cell phone, desktop, laptop, tablet, watch, other computing device or other device that may be coupled to a computing device (e.g. smartcard) or biometric device (e.g. fingerprint reader) may be configured to be a FIDO credential for multiple identities.

In an example, an authentication gesture may comprise connecting an authenticator device (e.g. a USB key, a smartphone or a badge) to a computing device (e.g. via USB, BT, NFC) and performing a biometric gesture to unlock the credentials stored on the authenticator device.

It is notable that identity is not synonymous with credentials. For example, multiple credentials may be attached to the same identity and multiple identities may be attached to the same credential. In an example, a user can sign in with a username and password or an authenticator application on a cell phone. A user or another (e.g. a user admin) may establish at least one common set of credentials for multiple identities or accounts, which may be recognized by an authentication system that is multi-identity aware.

A user may have a few or many identities, whether for personal, business, mixed or other purposes. In an example, a user may have personal and business accounts with a file hosting service such as Microsoft® OneDrive® and/or an email service such as Microsoft® Outlook®. In another example, a user may have multiple business (e.g. employee) accounts with employer A and employer B for a shift scheduling service, such as Microsoft® Shift Calendar or Microsoft® Teams Calendar. In other words, a user may have different accounts for different contexts.

A user may (e.g. additionally or alternatively) have multiple identities (e.g. personal, business, other) across multiple platforms or independent authentication systems (e.g. Microsoft®, Google™, Yahoo®, Facebook® and so on). Multiple authentication systems may implement authentication that permits signing in to multiple accounts (e.g. across systems) with a single gesture. In an example, a FIDO-compatible key may hold multiple user identities across multiple systems. A single sign-in gesture may unlock a user's accounts across multiple systems (e.g. Microsoft®, Google™, Yahoo!®, Facebook® and so on).

It may be advantageous for a user (e.g. in terms of time, stress, efficiency) to reduce many different credentials to a common set of credentials. A user may prefer to have multiple (e.g. all) identities available based on single sign-in gesture, allowing a user to move between various personal and business applications and/or between various social media applications with a single sign-in gesture. A user may desire to integrate contexts or identities, for example, to view information for multiple personal and/or business accounts at the same time, whether alternately or concurrently. For example, a user may desire to see combined emails from Microsoft®, Google™ and Yahoo!® accounts based on a single sign-in. For example, a shiftworker with two jobs, one at company A and another at company B, may prefer to view (e.g. based on a single sign-in) a combined shift calendar that merges information from user identity A created by company A and user identity B created by company B.

User 116 may log in to accounts (e.g. to use one or more resources such as application 112, data in databases and so on with one or more user identities) through computing device 110, network 105 and authentication server 140. In an example, user 116 may, for example, (i) launch application 112 (e.g. locally or through a Web browser), (ii) select “sign-in” to application 112, (iii) be redirected to authentication server 140, (iii) be presented with a request to provide credentials, (iv) provide credentials (e.g. cell phone number and OTC received by the phone), (v) have credentials validated, (vi) be placed in session with identities associated with the validated credentials and (vii) be redirected back to application 112, able to interact with multiple identities based on the single sign-in gesture.

Application 112 may comprise any application. Application 112 may comprise, for example, a Web application (e.g. Microsoft® Office 365® Web applications) or a locally executed application (e.g. Microsoft® Office Word, Excel®), which may access data in a database (e.g. through an application programming interface (API) or agent). Application 112 may be viewed and interacted with in a Web browser application executed by computing device 110. Application 112 may or may not be aware of a user's capability to sign in to multiple accounts, identities or contexts with a single sign in gesture. Application 112 may receive one or more session artifacts (e.g. session identity A, session identity B) at a time (e.g. based on application capabilities) in applicable forms, such as cookie(s) or token(s) 114. Some examples are discussed below after introducing session manager 146.

In an example, application 112 may comprise Microsoft® Teams application and authentication server 140 may comprise Azure® AD®. User 116 may launch the Teams application. Teams may search for user 116 to determine whether there is a current/active user session for user 116. For example, various versions of the Teams application may search for user 116 in an identity library (e.g. for desktop version), search for mobile tokens (e.g. in the mobile version), search for cookies in its domain (e.g. for web app version). Application 112 (e.g. Teams) may invoke a sign in function that redirects to authentication server 140 (e.g. Azure AD), for example, when a current session does not exist for user 116. Application server 140 may present a sign in page (e.g. login.microsoft.com). User 116 may enter a username (e.g. phone number or email), press next button, then enter OTC provided to phone or email. Upon verifying that user 116 has possession of the phone or email account, authentication server 140 may reveal multiple accounts/identities and may inquire which identities should have active sessions.

Authentication server 140 may provide (e.g. cloud-based) user authentication services to many users that may be, for example, associated with many different customers (e.g. personal, business and/or other accounts) of authentication server 140. Authentication server 140 may permit user admins from each customer to control user identity and access information for their respective employees and customers. User authentication and authorization may be decoupled from resources. Decoupling user authentication and authorization from resources permits authentication and authorization definitions (specifications) to apply across a plurality of resources (e.g. inter-resource or cross-resource definition). Resources may validate user authentication and authorization, for example, by validating a token provided by a user with authorization server 140. Decoupling user authentication and authorization from resources permits centralized management of user identities and access privileges to information and resources. An example of authentication server 140 is Microsoft® Azure® Active Directory®.

In an example, there may be multiple authentication servers operated by different service providers, e.g., Microsoft®, Google™, Yahoo!®. User 116 may have one or more identities on one or more authentication platforms. Each respective platform may manage identities, validate credentials and manage user sessions.

An authorization server (not shown) may be integrated with or separate from authentication server 140. An authorization service may provide authorization services, for example, by maintaining and providing user permissions. An authorization server may be implemented, for example, as a cloud authorization service.

Secured resources (e.g. resources secured by user authentication and/or authorization) may include any type of resource, including but not limited to computing or processing resources, software resources (e.g., software as a service (SaaS), platform as a service (PaaS), etc.), storage resources (e.g., physical storage devices, local storage devices, cloud-based storages, hard disk drives, solid state drives, random access memory (RAM) devices, etc.), databases, etc.

Authentication server 140 may comprise any one or more computing devices, servers, services, local processes, remote machines, web services, etc. for hosting, managing, and/or providing authentication services to users (e.g. user 116, user admin A 124, user admin B 134). In an example, authentication server 140 may comprise a server located on an organization's premises and/or coupled to an organization's local network, a remotely located server, a cloud-based server (e.g., one or more servers in a distributed manner), or any other device or service that may host, manage, and/or provide user authentication services. Authentication server 140 may be implemented as a plurality of programs executed by one or more computing devices. Authentication server programs may be separated by logic or functionality. In an example (e.g. as shown in FIG. 1), authentication server 140 may comprise, for example, identity manager 142, identity validator 144 and session manager 146.

Identity manager 142 may provide an identity management service. Identity manager 142 may manage a directory (e.g. one or more searchable directories, libraries, lists or tables) 143 of users, which may be segregated by or associated with identity providers, such as company A, company B, and so on. Directory 143 may implement one or more layers of security (e.g. as may be known in the art) to secure user identities. In an example, a user directory may comprise one or more properties of a user, such as user identities, valid credentials, name, address, email, phone number, computer IP address(es), access level(s), an indication whether a user is subject to multifactor authentication (MFA), etc. User admin A 124 may, for example, create an identity (e.g. user identity A) for user 116 associated with company A, which may be one of multiple identities for user 116. User admin B 134 may, for example, create an identity (e.g. user identity B) for user 116 associated with company B, which may be one of multiple identities for user 116. User 116 and/or others may create other identities for user 116 with identity manager 142.

Identity manager 142 may manage one or more identities for user 116 while another identity manager (e.g. in another authentication platform) may manage one or more other identities for user 116.

Identity validator 144 may be configured to receive and validate credentials provided by users (e.g. user 116) attempting to sign in (e.g. identity A credential, identity B credential). Credentials for identity A and identity B may be the same (e.g. identical) or may be partially different, but may be provided during a single sign-in procedure. For example, MFA may cause user 116 to provide a plurality of credentials, e.g., including a first credential required for user identity A and user identity B and a second credential required for user identity B. Upon login, authentication server 140 (e.g. identity validator 144) may, for example, determine whether a user is subject to MFA. A decision may be based on input by user 116 who, for example, may indicate a preference for a single sign-in to unlock a plurality (e.g. all) identities. Credentials required to unlock (e.g. all) identities may be known to identity manager 142 and/or identity validator 144, which may or may not lead to implementation of MFA challenges to provide required credentials. Identity validator 144 may access directory 143 managed by identity manager 142, for example, to search for and determine whether credentials provided by user 116 are valid (e.g. whether they match credentials in directory 143). Identity validator 144 may validate or invalidate received credentials by searching for matching credentials in directory 143 (or otherwise directly or indirectly comparing received credentials to known valid credentials).

User login credentials may comprise any information that may be used to verify user identity. Credential categories may be generalized as something a user knows (e.g. answers to one or more prompts or questions, such as a username, a password, a name of first pet and so on), something a user has (e.g. a device storing a cryptographic key) or something a user is (e.g. biometric information, such as retina scan, face scan, fingerprint and so on). MFA may combine multiple types of credentials. Multiple (e.g. all) identities may have common credentials, such as, for example, (i) a user's cell phone number combined with a password or a randomly generated OTC that would be texted to the user's phone number and entered by the user, (ii) a user's email address and a password or an OTC that would be emailed to the user's email address and entered by the user, (iii) a cryptographic key (e.g. FIDO-compatible key) and an unlock gesture (e.g. biometric information or a PIN). User 116 may manage credentials (e.g. passwords, phone numbers), for example, to make them consistent with other credentials for multiple identities.

In an example, a FIDO-compatible key in possession of user 116 may contain a list of user identities on one or more platforms. One sign-in gesture may unlock multiple user identities on one or more authentication platforms by providing credentials to each authentication platform for validation and session management for respective identities.

Identity validator 144 may validate credentials for one or more identities for user 116 while another identity validator (e.g. in another authentication platform) may validate credentials for one or more identities for user 116.

Session manager 146 may manage (e.g. create, refresh, destroy) user sessions for multiple user identities. Session manager 146 may generate sessions and session artifacts, for example, when identity validator indicates that user 116 provided valid credentials for a plurality of identities. Session manager 146 may create sessions for all identities attached to or associated with credential(s) provided during a single sign-in gesture. Session indicia may comprise, for example, session artifacts provided to a resource (e.g. application) or other entity (e.g. Web browser) for local storage and presentation. In an example (e.g. as shown in FIG. 1), a token (e.g. token 148) generated by session manager 146 may comprise a plurality of (e.g. all) session artifacts, e.g., session identity A, session identity B and so on, for multiple (e.g. all) identities. In an (e.g. another) example, session artifacts may be separated (e.g. one session artifact per token or cookie). Session manager 146 may generate and/or provide session artifacts together or separately (e.g. as needed). In an example, session manager 146 may generate sessions and session artifacts and provide the session artifacts for all identities to a multi-identity aware application. Session manager 146 may generate sessions, generate session artifacts, and provide session artifacts as needed or requested or based on limitations of a resource (e.g. an application that may be capable of receiving only one session artifact at a time). In an example, session manager 146 may manage a table associating authenticated user credentials with multiple identities with indications which identities have and do not have existing sessions and session artifacts, which table may be used to generate appropriate user interfaces for user 116 upon return to session manager 146 (e.g. to add identities to or remove identities from active sessions based on a prior single authentication gesture.

A session artifact may comprise any (e.g. tamper-resistant or tamper-proof) indicia of a session. A session artifact may comprise, for example, a cryptographic key generated during authentication. Session artifacts may take a variety of forms (e.g. token, cookie). Session artifacts may be generated, for example, by session manager 146, e.g., based on an indication by identity validator 144 that a user provided valid credentials for a plurality of identities. Session artifacts may be provided by session manager 146 for local storage. Session artifacts (e.g. in their respective form such as token 148) may be stored, for example, at a client computing device, such as computing device 110 (e.g. in a Web browser or application such as application 112).

A session artifact may be presented (e.g. to a resource and/or to authentication server 140), for example, in requests for resources (e.g. an application, information and so on), requests to refresh a session artifact, etc. In an example, a browser or application (e.g. application 112) may provide a session artifact (e.g. in the form of a token or cookie such as token 148) when (e.g. each time) it requests a new resource (e.g. a webpage). Local storage and presentation of a session artifact may avoid user sign-in, for example, as the user navigates between pages in an application or as the user browses webpages. Session artifacts may be platform specific. Examples of tokens include access tokens, which may be valid for extended periods, and refresh tokens, which may require periodic refresh.

A token may comprise, for example, an identity token, access token or refresh token. An access token (e.g. provided by authentication server 140) may comprise an indication of one or more authorization privileges. In an example, an access token may include any object (e.g., a set of data) that enables a computing device, computing environment, and/or applications to access a resource. For example, an access token may be a file or other object that includes one or more of an identifier for the token, an identifier for the associated session, an identifier for an application requesting access, a user identifier for the user of the application requesting access, etc. Information in a token may include, for example, information about which group a user belongs to, name, email address, user sensitivity level for resource access and use, etc.

In an example, an access token may comprise a JavaScript Object Notation (JSON) web token (referred to as a JWT) object signed by an authentication provider (e.g. authentication server 140). A JWT may comprise three pieces (e.g. a header, payload or body and signature). A header may provide information about how to validate a token (e.g. including information about the type of token and how it was signed, such as the key and encryption method used to sign the token). A payload may contain data about a user or application that may be calling an application or resource (e.g. service, database). A signature may comprise raw material that may be used to validate a token. In an example, a token issued by an authentication provider may be signed using an asymmetric encryption algorithm, such as RSA 256. Pieces of a JWT object may be separated by a period and (e.g. separately) Base64 encoded. In an example, an access token may be accompanied by metadata about the access token (e.g. for consumption by an application or resource receiving a token). In an example, metadata information may include an expiry time of an access token and the scope(s) for which the access token is valid. This data may permit applications and resources to intelligently cache access tokens without having to parse the access token itself. Access tokens may provide helpful information for use in authentication and authorization validation, such as the user, client, issuer, permissions, etc.

Session manager 146 may be configured to store each generated session artifact (e.g. token 148) in a suitable storage device (e.g. local or cloud-based storage). Accordingly, when application 112 attempts to access a resource (e.g. database, webpage and so on) by providing a token (e.g. token 148) to a resource, a resource (e.g. resource manager) may seek confirmation that the provided token is authentic (e.g. issued by authentication server 140) and valid (e.g. not expired) compared to token 148 stored at or by authentication server 140 prior to granting access to the requested resource. Session manager 146 may periodically refresh session artifacts (e.g. tokens) and destroy tokens (e.g. when user 116 ends a session or a session otherwise ends).

Session manager 146 may manage sessions for one or more identities for user 116 while another session manager (e.g. in another authentication platform) may manage sessions for one or more identities for user 116.

As previously indicated, application 112 (e.g. a Web browser rendering a Web application) may or may not be multi-identity aware, e.g., configured to simultaneously receive multiple session artifacts for multiple user identities (e.g. from session generator 146). An indication of multi-identity awareness may be provided, for example, in registration parameter(s) provided to authentication server 140 and/or in signaling (e.g. in a call to authentication server 140 to authenticate user 116). Authentication server 140 (e.g. session manager 146) may provide (and application 112 may receive) multiple session artifacts at the same time (e.g. in one or more tokens or cookies), for example, when application 112 is multi-identity aware. Authentication server 140 (e.g. session manager 146) may proxy logic for applications that may not be multi-identity aware. For example, session manager 146 may generate multiple session artifacts based on a single authentication gesture, but may retain or hold session artifacts until sought by application 112. For example, session manager 146 may provide a session artifact for session identity A (e.g. a default or selected identity) to application 112 at a first time and may provide a session artifact for session identity B to application 112 at a second time based on the single authentication gesture by user 116 without any additional sign in procedures.

In an example implementation for an application to indicate it is multi-identity aware, a protocol extension may be built on OpenID connect (OIDC) authentication protocol, which may be based on OAuth 2.0. In an example, a protocol extension may permit resources (e.g. applications) to indicate to an authorization provider (e.g. suing a standard protocol) that if a user has multiple identities associated with credentials then provide all identities. In an example a parameter may comprise, for example, multi-identity or multi-token support=true).

User 116 may (e.g. when application 112 may not be multi-identity aware), for example, select “add another account” in application 112, be redirected to authentication server, which may redirect back to application 112 with the additional session artifact for the additional identity without any additional sign-in, allowing user 116 to work alternately or concurrently with both contexts or identities.

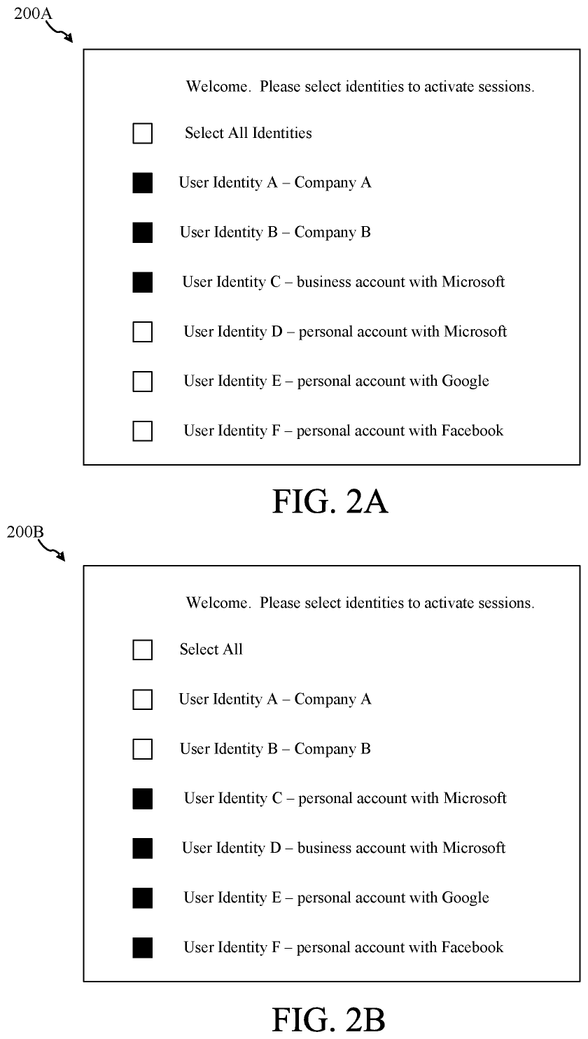

FIGS. 2A and 2B are examples of a user interface for signing in to multiple accounts with a single gesture, according to an example embodiment. FIGS. 2A and 2B show examples of a user interface and contents of the user interface that may be provided, for example, after identity validator 144 validates credentials (e.g. provided by user 116) for multiple identities. In an example, user 116 may be asked to select one or more identities for session activation by session manager 146 (and/or session managers on other authentication platforms). In an example, user 116 may indicate (e.g. in response to an inquiry) which identity(ies) user 116 desires to be active for one or more resources. User 116 may (e.g. subsequently) return to select additional, different or all identities based on the prior single sign in gesture without an additional sign in. Session manager 146 may generate sessions and session artifacts and/or provide session artifacts (e.g. to application 112 or Web browser), for example, based on logic at the direction of a user admin, at the direction of user 116, by default, by selection, etc.

In example user interface 200A in FIG. 2A, user 116 may be presented with six identities associated with the credentials provided during the single sign-in gesture, including User Identity A—Company A, User Identity B—Company B, User Identity C—business account with Microsoft, User Identity D—personal account with Microsoft, User Identity E—personal account with Google and User Identity F—personal account with Facebook. User 116 may select one or more identities individually or may select all identities. A user identity may or may not be presented with additional information, such as a purpose or association related to an identity (e.g. business, personal, particular company). As illustrated, user 116 selected user identities A, B and C. Upon selection, session manager 146 may create sessions and session artifacts for selected identities. As previously noted, session manager 146 may provide session artifacts to application 112, for example, based on a configuration or capabilities of application 112. User may use identities A, B and C (e.g. as application 112 and/or other resources allow) based on a single sign-in gesture.

User 116 may return to a user interface provided by session manager 146, for example, by selecting add or change account in application 112. In example user interface 200B in FIG. 2B, user 116 may (e.g. again) be presented with six identities associated with the credentials provided during the single sign-in gesture, including User Identity A—Company A, User Identity B—Company B, User Identity C—business account with Microsoft, User Identity D—personal account with Microsoft, User Identity E—personal account with Google and User Identity F—personal account with Facebook. Session manager 146 may indicate current selection(s) and may permit user 116 to change selections. User 116 may select one or more identities individually or may select all identities. As illustrated, user 116 changes prior selections from user identities A, B and C to user identities C, D, E and F by deselecting identities A and B, keeping identity C selected and selecting identities D, E and F. Upon selection, session manager 146 may create sessions and session artifacts for selected identities. Session manager 146 and application 112 may, for example, retain or destroy sessions and session artifacts for user identities A and B. As previously noted, session manager 146 may provide session artifacts to application 112, for example, based on a configuration or capabilities of application 112.

Multiple identities or contexts may be provided with privacy for user 116. For example, company A may not be made aware that user 116 also has an identity with company B and vice versa.

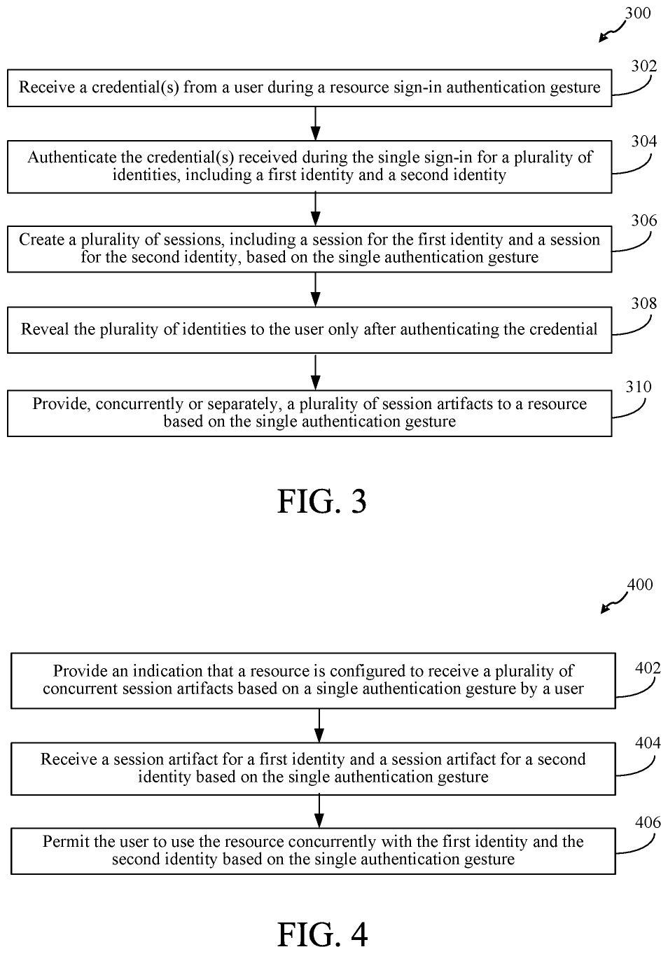

Implementations are not limited to the examples shown. Any number of computing devices and/or servers (including but not limited to machines and/or virtual machines) may be coupled in any manner via any type of computing environment. For example, one or more of computing device, server or storage components may be co-located, located remote from each other, combined or integrated on or distributed across one or more real or virtual machines. For example, authentication server 140 may include an authorization server. Example system 100 or components therein may operate, for example, according to example methods presented in FIGS. 3 and 4.

Embodiments may also be implemented in processes or methods. For example, FIG. 3 shows a flowchart of a method for signing in to multiple accounts with a single gesture, according to an example embodiment. Embodiments disclosed herein and other embodiments may operate in accordance with example method 300. Method 300 comprises steps 302-310. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 3. FIG. 3 is simply one of many possible embodiments. Embodiments may implement fewer, more or different steps.

Method 300 comprises step 302. In step 302, a credential(s) may be received from a user during a resource sign-in authentication gesture. For example, as shown in FIG. 1, user 116 may (e.g. using computing device 110) provide credentials to authentication server 140 after application 112 redirects user 116 to authentication server 140. User 116 may provide credentials (e.g. user name, password, biometric information and so on) necessary for identity validator 144 to validate multiple identities managed by identity manager 142.

In step 304, credential(s) received during the single sign-in may be authenticated for a plurality of identities, including a first identity and a second identity. For example, as shown in FIG. 1, identity validator 144 may search directory 143 for a plurality of matches to authenticate credentials received during the single sign-in. In an example (e.g. as shown in FIG. 1), identity validator 144 matched received credentials to at least two identities, including User Identity A—Company A and User Identity B—Company B, with other matches shown in FIGS. 2A and 2B, including User Identity C—business account with Microsoft, User Identity D—personal account with Microsoft, User Identity E—personal account with Google and User Identity F—personal account with Facebook.

In step 306, a plurality of sessions, including a session for the first identity and a session for the second identity, may be created based on the single authentication gesture. For example, as shown in FIG. 1, session manager 146 generates at least two sessions and session artifacts, e.g., session identity A and session identity B in token 148, which is provided to application 112.

In step 308, the plurality of identities may be revealed to the user only after authenticating the credential. For example, as shown in FIG. 2, authentication server 140 presents user 116 with a user interface showing identities only after identity validator 144 authenticated credentials for the identities.

In step 310, a plurality of session artifacts may be provided, concurrently or separately, to a resource based on the single authentication gesture. For example, as shown in FIG. 1, session manager 146 provides token 148, with at least two session artifacts (e.g. session identity A and session identity B) to application 112.

FIG. 4 shows a flowchart of a method for signing in to multiple accounts with a single gesture, according to an example embodiment. Embodiments disclosed herein and other embodiments may operate in accordance with example method 400. Method 400 comprises steps 402-406. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 4. FIG. 4 is simply one of many possible embodiments. Embodiments may implement fewer, more or different steps.

Method 400 comprises step 402. In step 402, an indication may be provided that a resource is configured to receive a plurality of concurrent session artifacts based on a single authentication gesture by a user. For example, as shown in FIG. 1, application 112 may provide an indication (e.g. in registration with or user redirect to authentication server 140) that it is multi-identity aware, configured to receive multiple session artifacts at the same time from session manager 146.

In step 404, a session artifact may be received for a first identity and a session artifact may be received for a second identity based on the single authentication gesture. For example, as shown in FIG. 1, application 112 received token 148 comprising session artifacts session identity A and session identity B, respectively, for user identity A and user identity B.

In step 406, the user may be permitted to use the resource concurrently with the first identity and the second identity based on the single authentication gesture. For example, as shown in FIG. 1, user 116 may use application 112 concurrently with user identity A and user identity B based on the single authentication gesture with authentication server 140.

### III. Example Computing Device Embodiments

As noted herein, the embodiments described, along with any modules, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

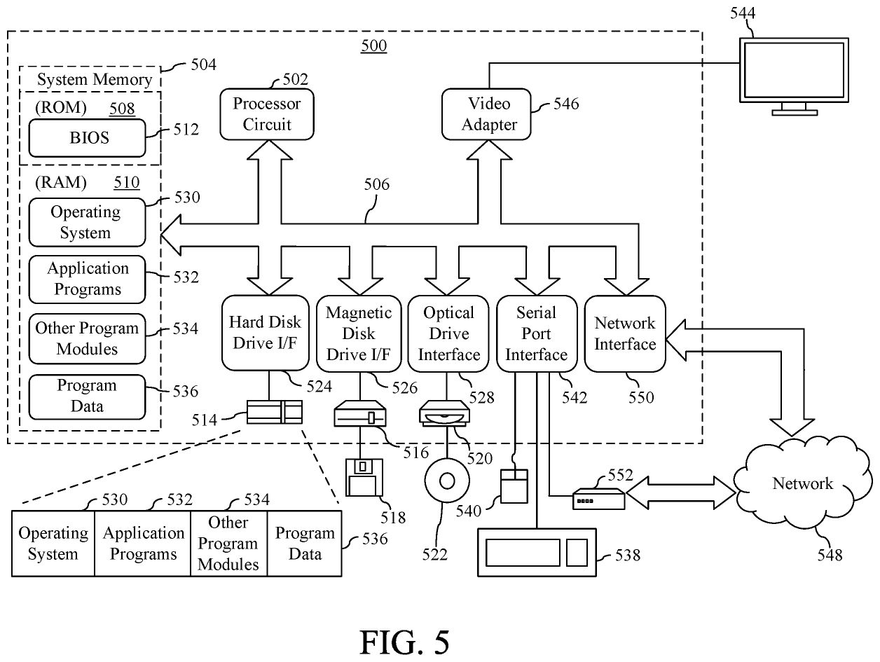

FIG. 5 shows an exemplary implementation of a computing device 500 in which example embodiments may be implemented. Consistent with all other descriptions provided herein, the description of computing device 500 is a non-limiting example for purposes of illustration. Example embodiments may be implemented in other types of computer systems, as would be known to persons skilled in the relevant art(s).

As shown in FIG. 5, computing device 500 includes one or more processors, referred to as processor circuit 502, a system memory 504, and a bus 506 that couples various system components including system memory 504 to processor circuit 502. Processor circuit 502 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 502 may execute program code stored in a computer readable medium, such as program code of operating system 530, application programs 532, other programs 534, etc. Bus 506 represents one or more of any of several types of bus structures, including a memory bus or memory controller, a peripheral bus, an accelerated graphics port, and a processor or local bus using any of a variety of bus architectures. System memory 504 includes read only memory (ROM) 508 and random-access memory (RAM) 510. A basic input/output system 512 (BIOS) is stored in ROM 508.

Computing device 500 also has one or more of the following drives: a hard disk drive 514 for reading from and writing to a hard disk, a magnetic disk drive 516 for reading from or writing to a removable magnetic disk 518, and an optical disk drive 520 for reading from or writing to a removable optical disk 522 such as a CD ROM, DVD ROM, or other optical media. Hard disk drive 514, magnetic disk drive 516, and optical disk drive 520 are connected to bus 506 by a hard disk drive interface 524, a magnetic disk drive interface 526, and an optical drive interface 528, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 530, one or more application programs 532, other programs 534, and program data 536. Application programs 532 or other programs 534 may include, for example, computer program logic (e.g., computer program code or instructions) for implementing computing device 102, virtual machine 104, authorization token manager 106, authorization server 108, token issuer 110, resource server 112, resource manager 114, secured resources 116, trust level assignor 304, token requestor 306, identity validator 314, token generator 316, resource access provider 318, resource protector 320, resource snapshot 322, flowchart 200, flowchart 400, and/or flowchart 500 (including any suitable step of flowcharts 200, 400, or 500) and/or further example embodiments described herein.

A user may enter commands and information into the computing device 500 through input devices such as keyboard 538 and pointing device 540. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 502 through a serial port interface 542 that is coupled to bus 506, but may be connected by other interfaces, such as a parallel port, game port, or a universal serial bus (USB).

A display screen 544 is also connected to bus 506 via an interface, such as a video adapter 546. Display screen 544 may be external to, or incorporated in computing device 500. Display screen 544 may display information, as well as being a user interface for receiving user commands and/or other information (e.g., by touch, finger gestures, virtual keyboard, etc.). In addition to display screen 544, computing device 500 may include other peripheral output devices (not shown) such as speakers and printers.

Computing device 500 is connected to a network 548 (e.g., the Internet) through an adaptor or network interface 550, a modem 552, or other means for establishing communications over the network. Modem 552, which may be internal or external, may be connected to bus 506 via serial port interface 542, as shown in FIG. 5, or may be connected to bus 506 using another interface type, including a parallel interface.

As used herein, the terms “computer program medium,” “computer-readable medium,” and “computer-readable storage medium” are used to refer to physical hardware media such as the hard disk associated with hard disk drive 514, removable magnetic disk 518, removable optical disk 522, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 532 and other programs 534) may be stored on the hard disk, magnetic disk, optical disk, ROM, RAM, or other hardware storage medium. Such computer programs may also be received via network interface 550, serial port interface 542, or any other interface type. Such computer programs, when executed or loaded by an application, enable computing device 500 to implement features of example embodiments described herein. Accordingly, such computer programs represent controllers of the computing device 500.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for signing into multiple accounts with a single gesture. Multiple sessions may be generated for multiple user identities based on a single authentication gesture, such as providing a phone number or email and a texted or emailed one-time code or providing a FIDO-compatible key and an unlock gesture (e.g. biometric information or a PIN). Resources, such as applications, need not, but may be multi-identity aware to support signing into multiple accounts with a single gesture. Users may utilize their multiple identities without any additional sign-ins. Resources or session managers may receive multiple session artifacts concurrently or separately without any additional sign-ins. Resources may indicate a capability to receive multiple session artifacts, for example, in registration or call parameters. Multiple identities may be revealed only after verification, for example, to prevent divulging identities to third parties aware of usernames such as phone numbers and email addresses.

In an example, a method for signing a user in to multiple accounts with a single authentication gesture may comprise, for example, receiving, by an authentication provider, a credential from a user signing in to use a resource; authenticating the credential for a plurality of identities, including a first identity and a second identity; and creating a plurality of sessions for the plurality of identities comprising a session for the first identity and a session for the second identity based on the single authentication gesture.

In an example, the method may further comprise, for example, revealing the plurality of identities to the user only after authenticating the credential.

In an example, the method may further comprise, for example, prompting the user to indicate which identity or identities in the plurality of identities the user desires to be active for the resource.

In an example, the method may further comprise, for example, providing, to the resource, a session artifact for the first identity.

In an example, the method may further comprise, for example, receiving an indication that the user desires to switch to or add the second identity; and providing, to the resource, a session artifact for the second identity based on the single authentication gesture without an additional sign in.

In an example, the method may further comprise, for example, determining that the resource is multi-identity aware, configured to receive a plurality of concurrent session artifacts; and providing concurrently, to the resource, a session artifact for the first identity and a session artifact for the second identity based on the single authentication gesture.

In an example, the first identity may be created by a first identity provider and the second identity may be created by a second identity provider.

In an example, the credential may be a passwordless credential. In an example, the passwordless credential may comprise one of the following: (i) a phone number combined with a one-time code (OTC) texted to the phone number and entered by the user, (ii) an email address and the OTC emailed to the email address and entered by the user, or (iii) the user's biometric information.

In an example, an authentication server may comprise, for example, one or more processors; and one or more memory devices that store program code configured to be executed by the one or more processors, the program code comprising: an identity validator configured to: receive a credential from a user performing a single authentication gesture; and validate the credential for a plurality of identities, including a first identity and a second identity based on the single authentication gesture; and a session generator configured to: create a plurality of sessions for the plurality of identities comprising a session for the first identity and a session for the second identity based on the single authentication gesture.

In an example, the identity validator may be further configured to: reveal the plurality of identities to the user only after validating the credential.

In an example, the session generator may be further configured to: provide a session artifact for the first identity.

In an example, the identity validator may be further configured to: receive an indication the user desires to use the second identity; and the session generator may be further configured to: provide a session artifact for the second identity based on the single authentication gesture without an additional sign in.

In an example, the session generator may be further configured to: determine that a resource is configured to receive a plurality of concurrent session artifacts; and provide concurrently, to the resource, a session artifact for the first identity and a session artifact for the second identity based on the single authentication gesture.

In an example, the first identity may be created by a first identity provider and the second identity may be created by a second identity provider.

In an example, a computer-readable storage medium may have program instructions recorded thereon that, when executed by a processing circuit, perform a method comprising, for example, providing an indication that a resource is configured to receive a plurality of concurrent session artifacts for a first identity and a second identity based on a single authentication gesture by a user; and receiving a first session artifact for the first identity and a second session artifact for the second identity based on the single authentication gesture.

In an example, the method may further comprise, for example, permitting a user to use the resource concurrently with the first identity and the second identity based on the single authentication gesture.

In an example, the resource may be configurable to combine or merge information for the first identity and the second identity based on the single authentication gesture.

In an example, the first session artifact and the second session artifact may be received together based on the single authentication gesture.

In an example, the first session artifact and the second session artifact may be received separately based on the single authentication gesture without an additional sign in.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method performed by at least one computing device for signing a user in to multiple accounts with a single authentication gesture, comprising:
receiving, by an authentication provider, a credential from a user signing in to use a resource;
authenticating the credential for a plurality of identities, including a first identity and a second identity; and
creating a plurality of sessions for the plurality of identities comprising a session for the first identity and a session for the second identity based on the single authentication gesture.

2. The method of claim 1, further comprising:
revealing the plurality of identities to the user only after authenticating the credential.

3. The method of claim 2, further comprising:
prompting the user to indicate which identity or identities in the plurality of identities the user desires to be active for the resource.

4. The method of claim 1, further comprising:
providing, to the resource, a session artifact for the first identity.

5. The method of claim 4, further comprising:
receiving an indication that the user desires to switch to or add the second identity; and
providing, to the resource, a session artifact for the second identity based on the single authentication gesture without an additional sign in.

6. The method of claim 1, further comprising:
determining that the resource is multi-identity aware, configured to receive a plurality of concurrent session artifacts; and
providing concurrently, to the resource, a session artifact for the first identity and a session artifact for the second identity based on the single authentication gesture.

7. The method of claim 1, wherein the first identity was created by a first identity provider and the second identity was created by a second identity provider.

8. The method of claim 1, wherein the credential is a passwordless credential.

9. The method of claim 8, wherein the passwordless credential comprises one of the following: (i) a phone number combined with a one-time code (OTC) texted or phoned to the phone number and entered by the user, (ii) an email address and the OTC emailed to the email address and entered by the user, or (iii) the user's biometric information.

10. An authentication server, comprising:
one or more processors; and
one or more memory devices that store program code configured to be executed by the one or more processors, the program code comprising:
an identity validator configured to:
receive a credential from a user performing a single authentication gesture;
validate the credential for a plurality of identities, including a first identity and a second identity based on the single authentication gesture; and
a session generator configured to:
create a plurality of sessions for the plurality of identities comprising a session for the first identity and a session for the second identity based on the single authentication gesture.

11. The authentication server of claim 10, wherein the identity validator is further configured to:
reveal the plurality of identities to the user only after validating the credential.

12. The authentication server of claim 11, wherein the session generator is further configured to:
provide a session artifact for the first identity.

13. The authentication server of claim 12, wherein the identity validator is further configured to receive an indication that the user desires to use the second identity; and
wherein the session generator is further configured to provide a session artifact for the second identity based on the single authentication gesture without an additional sign in.

14. The authentication server of claim 11, wherein the session generator is further configured to:
determine that a resource is configured to receive a plurality of concurrent session artifacts; and
provide concurrently, to the resource, a session artifact for the first identity and a session artifact for the second identity based on the single authentication gesture.

15. The authentication server of claim 10, wherein the first identity was created by a first identity provider and the second identity was created by a second identity provider.

16. A computer-readable storage medium having program instructions recorded thereon that, when executed by a processing circuit, perform a method comprising:
providing an indication that a resource is configured to receive a plurality of concurrent session artifacts for a first identity and a second identity based on a single authentication gesture by a user; and
receiving a first session artifact for the first identity and a second session artifact for the second identity based on the single authentication gesture.

17. The computer-readable storage medium of claim 16, wherein the method further comprises:
permitting a user to use the resource concurrently with the first identity and the second identity based on the single authentication gesture.

18. The computer-readable storage medium of claim 16, wherein the resource is configurable to combine or merge information for the first identity and the second identity based on the single authentication gesture.

19. The computer-readable storage medium of claim 16, wherein the first session artifact and the second session artifact are received together based on the single authentication gesture.

20. The computer-readable storage medium of claim 16, wherein the first session artifact and the second session artifact are received separately based on the single authentication gesture without an additional sign in.
